(19) United States
(12) Patent Application Publication
(10) Pub. No.: US 2011/0130867 A1
(43) Pub. Date: Jun. 2, 2011

(54) MONEY HANDLING MACHINE AND MONEY DEPOSIT/DISPENSE SYSTEM

(76) Inventor: Yasuhiro Matsumoto, Hyogo-ken (JP)

(21) Appl. No.: 12/737,652

(22) PCT Filed: Aug. 4, 2008
(86) PCT No.: PCT/JP2008/063971

§ 371 Date: Feb. 3, 2011

(51) Int. Cl. G07D 13/00; G06F 19/00

(52) U.S. Cl. 700/216

(57) ABSTRACT

A money handling machine (10) includes: a money storage unit (40) configured for storing therein money; and money recycling mechanisms (20, 30), each adapted for temporarily storing the money taken from the exterior to the interior of a casing (11), in each of recycling money storage units (27, 34). Each of the money recycling mechanisms (20, 30) is arranged to be controlled under a first control authority, while the money storage unit (40) is arranged to be controlled under a second control authority. When a control unit (15) receives a delivery command, the control unit (15) performs a delivery process for feeding the money stored in each of the recycling money storage units (27, 34) to the money storage unit (40). Meanwhile, when receiving a closing command, the control unit (15) performs a closing process for calculating the amount of money regarding the closing process, which is the amount of money or quantity of money for each denomination thereof, in regard to the money having been subjected to the delivery process in a predetermined period of time. Further, when receiving a delivery-with-closing command, the control unit (15) performs a delivery-with-closing process, so as to first perform the delivery process, and then automatically perform the closing process, in succession to the end of the delivery process.

### FIELD OF THE INVENTION

This invention relates to a money handling machine configured to handle money under a first or second control authority, and also relates to a money deposit/dispense system including this money handling machine. It should be noted that the term “money”, as used herein, may be banknotes and/or coins.

### BACKGROUND OF THE INVENTION

In the past, the money handling machine, which is adapted for depositing the money, such as money from sale or the like, in a store or the like, dispensing the money, such as changes or the like, and delivering the money to a designated collector, such as a staff of an armored car company or the like, entrusted to collect the money from sale or the like, has been known. This money handling machine includes a money storage unit adapted for storing the money, and a money recycling mechanism adapted for temporarily storing therein the money taken from the exterior to the interior of a casing of the machine, and feeding the money temporarily stored in this money recycling mechanism or money taken from the exterior to the interior of the casing, to the money storage unit, or otherwise returning such money to the exterior of the casing. In this case, the control authority, under which the money stored in the money recycling mechanism (or money stored in an upper part of the money handling machine) is controlled, is separated from the control authority, under which the money stored in the money storage unit (or money stored in a lower part of the money handling machine) is controlled. Namely, the former control authority is provided on the side of the store, which is suitable for depositing and/or dispensing the money relative to the money handling machine, while the latter control authority is provided on the side of the designated collector in charge of collecting the money, such as the banknotes or the like, from the money handling machine. Therefore, the operation for depositing, dispensing, delivering or the like, for the money stored in the upper part of the money handling machine, and/or access to deposit/dispense information and/or total-amount data, in regard to the money stored in the upper part, can be performed by only an authorized operator on the side of the store. Meanwhile, the money stored in the lower part of the money handling machine can be collected by only the designated collector.

For instance, in JP3711068B, it is disclosed that a closing process is performed by the above described money handling machine. More specifically, a cash management system disclosed in this JP3711068B includes a control center and a money deposit machine installed in the store or the like. In this cash management system disclosed in the JP3711068B, once a closing command is sent to the cash management system, the closing process is performed in the money deposit machine, and then closing data is transmitted from the money deposit machine to the cash management center. Thereafter, the cash management center will deposit the money to a bank or the like, corresponding to the amount of money related to the received closing data.

Further, in JP2003-141609A, it is described that a delivery process is performed by the above described money handling machine. More specifically, a money deposit/dispense machine for store, which is disclosed in the JP2003-141609A, is configured for managing the cash deposited in this deposit/dispense machine, so as to distinguish the money to be prepared in the store for being dispensed as change or the like from the money from sale of the store that will be delivered to a financial institution, without being dispensed. In this case, the money from sale of the store, among the cash deposited in the money deposit/dispense machine designed for store, will be collected by the designated collector of the armored car company or the like. Further, in this money deposit/dispense machine for store, which is disclosed in the JP2003-141609A, once the delivery process is performed for transporting the money, from a recycling storage unit provided for storing therein the money to be prepared in the store to a cassette storage unit provided for storing therein the money for sale of the store, the authority, under which the money is controlled, is changed, from the control authority, under which the money to be prepared in the store is controlled, to the control authority, under which the money for sale of the store is controlled. For instance, this delivery process includes a predetermined amount of money delivery mode, in which a predetermined amount of money is transported from the recycling storage unit to the cassette storage unit, and a total amount of money delivery mode, in which all of the money stored in the recycling storage unit is transported to the cassette storage unit. More specifically, the money deposit/dispense machine for store disclosed in the JP2003-141609A is connected, via a telecommunication line, with a control center provided for the collector of the armored car company or the like, whereby this money deposit/dispense machine for store can transmit data on the money from sale of the store or the like to the control center.

### DISCLOSURE OF THE INVENTION

As described above, once the closing command is sent to the money deposit/dispense machine for store as disclosed in the JP3711068B, the closing process is performed for calculating the money (i.e., the amount of money regarding the closing process) having been subjected to the delivery process during a period of time from the previous closing process to the present closing process, and then the data on the so-calculated amount of money regarding the closing process will be transmitted to the control center. Thereafter, the control center that has received the data on the amount of money regarding the closing process will deposit the money to the bank or the like, corresponding to the so-received amount of money regarding the closing process. In this case, the closing process for transmitting the data on the amount of money regarding the closing process to the control center is performed, independently, from the delivery process, during which the control authority respectively provided to control the money is changed in the money deposit/dispense machine. Namely, it is necessary to perform both the closing process and delivery process by respectively providing the closing command and delivery command by the operator.

However, in the case of handling the cash after the business is ended in the store or the like, the closing process is sometimes performed, in succession, after the delivery process is ended, in order to attain an intended amount of money regarding the closing process. In this case, the amount of money to be delivered is first obtained, by subtracting the amount of money that is subjected to the delivery process already performed after the previous closing process, from the intended amount of money regarding the closing process, and then the delivery process is performed by inputting the so-obtained amount of money to be delivered. This work should be rather complicated for the operator. Besides, since it is necessary to perform the closing process after the delivery process is ended, the operator should wait for the completion of this delivery process.

In particular, in the case many operations should be performed, in a relatively short time, after the business is ended in the store or the like, such a waiting time of the operator may substantially degrade the working efficiency. Of course, the operator can perform another operation than the closing process until the delivery process is ended, and then perform the closing process after the completion of the delivery process. However, in such a case, the operator should perform two different operations. Therefore, such a busy work may tend to make the operator forget the second operation (i.e. the closing process), and thus leave it undone.

Meanwhile, in the case the intended amount of money is left in the money recycling mechanism, while the surplus money is delivered to the money storage unit, the input operation of the amount of money performed by the operator during the delivery process can be somewhat simplified. However, also in this case, the problem that the operator should wait until the delivery process is ended cannot be solved, thus still degrading the working efficiency of the operator.

The present invention was made in view of such circumstances. Therefore, it is an object of this invention to provide a money handling machine and a money deposit/dispense system including this money handling machine. Namely, according to the money handling machine and/or money deposit/dispense system of this invention, both the delivery process and the closing process following this delivery process can be performed, by one operation, thus eliminating the need that the operator should wait the completion of the delivery process, thereby significantly enhancing the working efficiency of the operator.

The money handling machine of this invention is adapted for handling the money, and includes: a casing; a money recycling mechanism provided in the casing and configured to be controlled under a first control authority; and a money storage unit provided in the casing and configured to be controlled under a second control authority; the money storage unit is configured to store therein the money, the money recycling mechanism is configured to temporarily store the money taken from the exterior to the interior of the casing, in a recycling money storage unit thereof, and is adapted to feed the money stored in the recycling money storage unit or money taken from the exterior to the interior of the casing, to the money storage unit, or return such money to the exterior of the casing, and there is further provided a control unit, the control unit performing a delivery-with-closing process, when receiving a delivery-with-closing command, so as to first perform a delivery process for feeding the money stored in the recycling money storage unit of the money recycling mechanism to the money storage unit, and then perform, in succession to the end of the delivery process, a closing process for calculating the amount of money regarding the closing process, which is the amount of money or quantity of money for each denomination thereof, in regard to the money having been subjected to the delivery process in a predetermined period of time.

In this money handling machine, the money recycling mechanism is arranged to be controlled under the first control authority, while the money storage unit is arranged to be controlled under the second control authority. With this configuration, when receiving the delivery command, the control unit performs the delivery process for feeding the money stored in the recycling money storage unit of the money recycling mechanism to the money storage unit (during this operation, the authority, under which the money subjected to the delivery process is controlled, is changed from the first control authority to the second control authority). Meanwhile, when receiving the closing command, the control unit performs the closing process for calculating the amount of money regarding the closing process, which is the amount of money or quantity of money for each denomination thereof, in regard to the money having been subjected to the delivery process in the predetermined period of time (more specifically, during the period of time from the previous closing process to the present closing process). Further, when receiving the delivery-with-closing command, the control unit performs the delivery-with-closing process, such that the delivery process is first performed, and then the closing process is automatically performed, in succession, after the delivery process is ended. As such, if the closing process is required to be performed in succession to the end of the delivery process, both the delivery process and closing process following this delivery process can be performed, in one operation, by only inputting the delivery-with-closing command to the control unit. This operation can eliminate the need for providing the waiting time after the operator performs the delivery process, thereby significantly enhancing the working efficiency of the operator.

In the money handling machine of this invention, it is preferable that when the control unit receives information on the amount of money regarding the closing process, together with the delivery-with-closing command, the control unit first performs the delivery process, for the money corresponding to the amount of money obtained by subtracting the amount of money having been subjected to the delivery process during the predetermined period of time before this delivery-with-closing process, from the amount of money regarding the closing process in the received information, and then performs the closing process.

In the money handling machine of this invention, it is preferable that when the control unit receives information on the amount of money to be delivered, together with the delivery-with-closing command, the control unit first performs the delivery process for the money corresponding to the amount of money to be delivered in the received information, and then performs the closing process.

In the money handling machine of this invention, it is preferable that when the control unit receives information on the amount of money to be left or information on the number of money to be left for each denomination thereof, together with the delivery-with-closing command, the control unit allows the money to be left in the recycling money storage unit, corresponding to the amount of money to be left or corresponding to the number of money to be left for each denomination thereof in the received information, while performing the delivery process for the surplus money, and then performs the closing process.

In the money handling machine of this invention, it is preferable that when the control unit receives only the delivery-with-closing command, the control unit allows the money to be left in the recycling money storage unit, corresponding to a preset amount of money or preset number of money for each denomination thereof, while performing the delivery process for the surplus money, and then performs the closing process.

In the money handling machine of this invention, it is preferable that when the amount of money stored in the recycling money storage unit reaches a predetermined amount, the control unit first performs the delivery process until the amount of money stored in the recycling money storage unit is reduced to a storage amount set in advance, which is less than the predetermined amount, and then automatically performs the closing process, in succession to the end of the delivery process.

A money deposit/dispense system according to this invention includes the above described money handling machine; and a central control unit provided to be isolated from the money handling machine, and connected, for communication, with the money handling machine, and after the control unit performs the closing process, the control unit transmits information on the amount of money regarding the closing process to the central control unit.

### BRIEF DESCRIPTION OF THE DRAWINGS

FIG. 1A is a block diagram illustrating one aspect of the construction of the money deposit/dispense system related to one embodiment of the present invention.

FIG. 1B is a block diagram illustrating another aspect of the construction of the money deposit/dispense system related to one embodiment of the present invention.

FIG. 2 is a perspective view showing the money handling machine included in the money deposit/dispense system shown in FIG. 1A or 1B.

FIG. 3A is a diagram schematically showing the construction of a banknote handling machine provided in the money handling machine shown in FIG. 2.

FIG. 3B is a diagram schematically showing the construction of a coin handling machine provided in the money handling machine shown in FIG. 2.

FIG. 4 is a control block diagram of the money handling machine shown in FIG. 2.

FIG. 5A is a diagram illustrating a series of operations of a delivery process in the banknote handling machine of the money handling machine shown in FIG. 2.

FIG. 5B is another diagram illustrating the series of operations of the delivery process in the banknote handling machine of the money handling machine shown in FIG. 2.

FIG. 6A is a diagram illustrating a series of operations of the delivery process in the coin handling machine of the money handling machine shown in FIG. 2.

FIG. 6B is another diagram illustrating the series of operations of the delivery process in the coin handling machine of the money handling machine shown in FIG. 2.

FIG. 7A is a diagram illustrating a series of operations of a mass delivery process in the banknote handling machine of the money handling machine shown in FIG. 2.

FIG. 7B is another diagram illustrating the series of operations of the mass delivery process in the banknote handling machine of the money handling machine shown in FIG. 2.

FIG. 7C is still another diagram illustrating the series of operations of the mass delivery process in the banknote handling machine of the money handling machine shown in FIG. 2.

FIG. 8A is a diagram illustrating a series of operations of a mass delivery process in the coin handling machine of the money handling machine shown in FIG. 2.

FIG. 8B is another diagram illustrating the series of operations of the mass delivery process in the coin handling machine of the money handling machine shown in FIG. 2.

FIG. 8C is still another diagram illustrating the series of operations of the mass delivery process in the coin handling machine of the money handling machine shown in FIG. 2.

### DETAILED DESCRIPTION OF THE INVENTION

Hereinafter, a money handling machine related to one embodiment of the present invention and a money deposit/dispense system including this money handling machine will be respectively described, with reference to the drawings. The money handling machine related to this embodiment includes a money storage unit arranged to be controlled under one control authority provided on the side of the designated collector and a money recycling mechanism arranged to be controlled under another control authority provided on the side of the store, and the money storage unit and money recycling mechanism are respectively provided in a casing of the money handling machine.

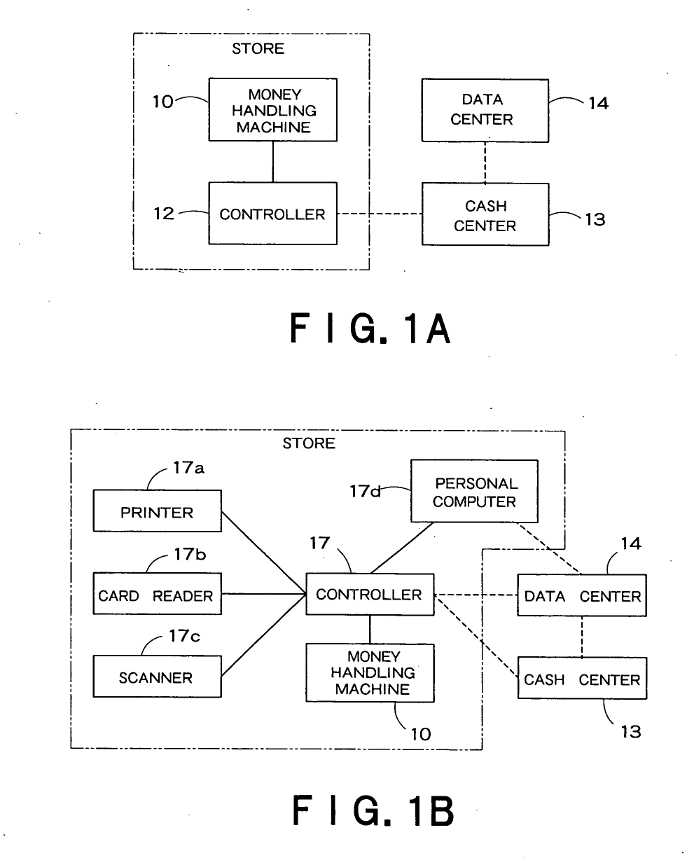

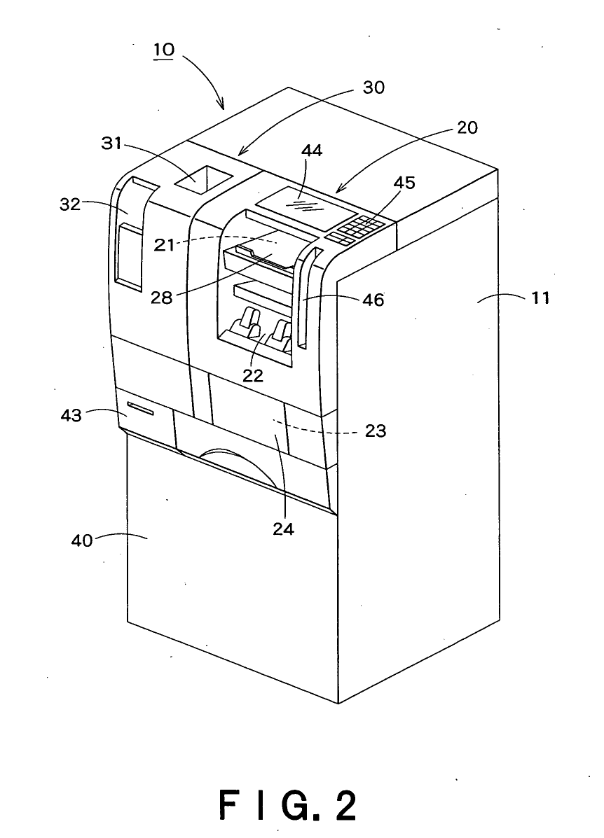

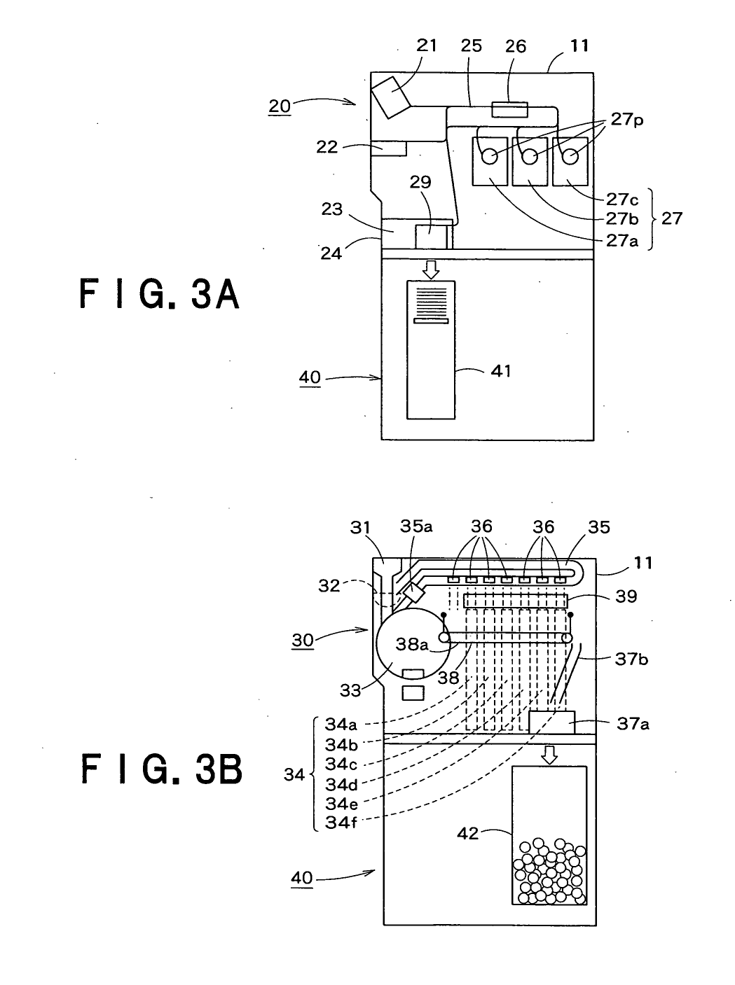

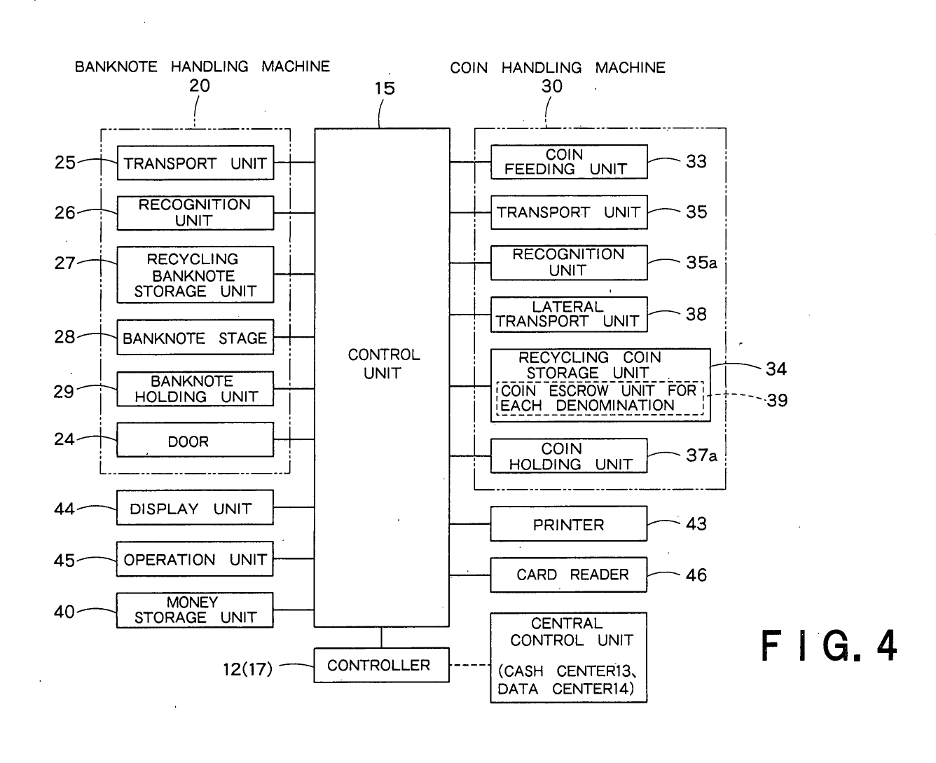

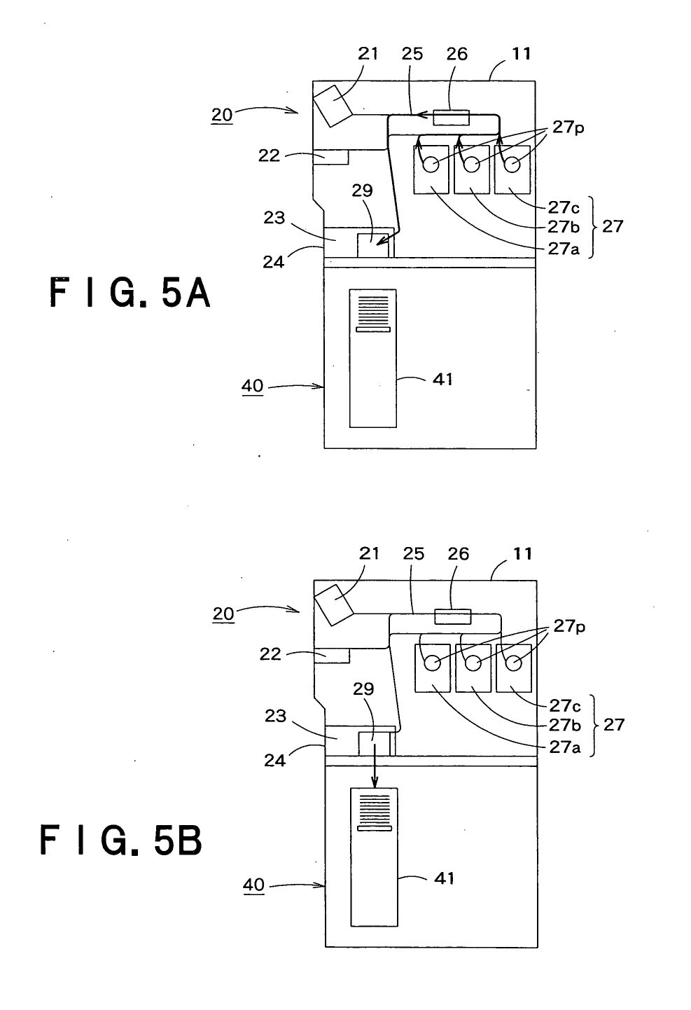

The money handling machine related to this embodiment is adapted for performing a supplement process, a depositing process, a dispensing process, a delivery process, a mass delivery process, an exchange from large denomination to small denomination process, an exchange from small denomination to large denomination process, a checking process, a counting process, a closing process, a delivery-with-closing process, a collection by staff process and the like, about the money including the coins and banknotes. FIGS. 1 through 8 are provided herein for respectively illustrating the money handling machine related to one exemplary embodiment of the present invention and the money deposit/dispense system including this money handling machine. Of these drawings, FIG. 1A shows a block diagram illustrating one exemplary aspect of the money deposit/dispense system of this embodiment. FIG. 1B shows a block diagram illustrating another aspect of the money deposit/dispense system of this embodiment. FIG. 2 shows a perspective view of the money handling machine included in the money deposit/dispense system shown in FIG. 1A or 1B. FIG. 3A schematically shows a construction of a banknote handling machine provided in the money handling machine shown in FIG. 2. FIG. 3B schematically shows a construction of a coin handling machine provided in the money handling machine shown in FIG. 2. FIG. 4 is a control block diagram in the money handling machine shown in FIG. 2. FIGS. 5 through 8 are provided for respectively illustrating the delivery process and/or mass delivery process in the banknote handling machine or coin handling machine of the money handling machine shown in FIG. 2.

As shown in FIG. 1A, the money deposit/dispense system of this embodiment includes a money handling machine 10 installed in one store, and a cash center 13 and a data center 14, which are respectively provided on the outside of the store, while being respectively isolated from the money handling machine 10. In addition, a central control unit is provided for each of the cash center 13 and data center 14. In the following description, each of the cash center 13 and data center 14 means the central control unit. Meanwhile, a controller 12 is provided to the money handling machine 10. This controller 12 is connected, by wire or wireless communication, with the cash center 13, and is thus adapted for receiving and transmitting a signal relative to the cash center 13. This configuration enables remote control of the money handling machine 10 from the cash center 13 via the controller 12. In this case, the controller 12 may be a communication control device or terminal, which is connected, via a LAN or the like means, with the money handling machine 10, or otherwise may be a communication unit provided in the money handling machine 10.

Further, as shown in FIG. 1A, the cash center 13 and data center 14 are connected, by wire or wireless communication, relative to each other, such that various data can be received and transmitted between the cash center 13 and the data center 14. Therefore, the information, which has been transmitted to the cash center 13 from the money handling machine 10 via the controller 12, in regard to the money including the banknotes, coins and the like respectively handled by the money handling machine 10, can also be sent to the data center 14. In the present invention, the central control unit is provided to each of the cash center 13 and data center 14. However, the manner of providing the central control unit is not limited to this aspect. For instance, the central control unit may be provided to only the cash center 13, or otherwise may be provided to only the data center 14. It should be noted that the construction of each of the money handling machine 10, controller 12, cash center 13 and data center 14 will be detailed later.

The construction of the money deposit/dispense system of this embodiment is not limited to such an aspect as shown in FIG. 1A. For instance, the money deposit/dispense system may be constructed as illustrated in FIG. 1B. It is true that the construction of the money deposit/dispense system shown in FIG. 1B is substantially the same as the construction of the money deposit/dispense system shown in FIG. 1A, in that both the two systems include the money handling machine 10, and the cash center 13 and data center 14, which are respectively provided on the outside of the money handling machine 10, while being respectively isolated relative to the money handling machine 10. However, the controller 17 provided to the money handling machine 10 shown in FIG. 1B has a further expanded function.

Namely, the controller 17 is connected, by wire or wireless communication, with each of the cash center 13 and data center 14, and is thus adapted for receiving and transmitting the signal relative to both the cash center 13 and data center 14.

In addition, the controller 17 provided to the money deposit/dispense system shown in FIG. 1B can have additional functions, such that this controller 17 can be further connected with a printer 17a, a card reader 17b and a scanner 17c. The printer 17a is provided for printing the information on the money including the banknotes, coins and the like, respectively handled by the money handling machine 10. The card reader 17b can also be connected with the controller 17 in addition to another card reader provided to the money handling machine 10, and is configured for reading ID information of an ID card carried by each operator. With this configuration, each operator can be identified, based on the signal related to the ID information of the operator inputted to the controller 17. The scanner 17c is configured to take an image of a serial number, a bar-code or the like of each banknote. Further, the controller 17 may serve as a router.

In addition, the controller 17 can also be connected with a personal computer 17d of the operator. In this case, the operator can operate the money handling machine 10 via the personal computer 17d connected with the controller 17. Furthermore, this personal computer 17d can serve to receive and transmit the signal relative to the data center 14.

Now, referring to FIGS. 2 through 4, the construction of the money handling machine 10 as shown in FIG. 1A or 1B will be described in more detail.

As shown in FIG. 2, the money handling machine 10 includes a casing 11 having a substantially rectangular parallelepiped shape. In this casing 11, a banknote handling machine 20 is located on the right side when seen from the front of the money handling machine 10, with a coin handling machine 30 located laterally, on the left side, relative to the banknote handling machine 20. In addition, a money storage unit 40 adapted for storing therein the coins and banknotes is provided in the casing 11 of the banknote handling machine 10, while being positioned below the banknote handling machine 20 and coin handling machine 30. In this case, the banknote handling machine 20 and coin handling machine 30 are respectively arranged to be controlled under the control authority provided on the side of the store. Meanwhile, the money storage unit 40 is arranged to be controlled under the control authority provided on the side of the designated collector.

Hereinafter, each component of the banknote handling machine 20, coin handling machine 30 and money storage unit 40 will be described in detail.

First, the construction of the money handling machine 20 will be described, with reference to FIGS. 2 and 3A. As shown in FIGS. 2 and 3A, the banknote handling machine 20 includes a banknote inlet 21 provided for taking the banknotes into the banknote handling machine 20, a banknote reject slot 22 provided for rejecting the banknotes that are counterfeit banknotes or that cannot be recognized, among the banknotes respectively taken in the banknote handling machine 20, and a banknote return slot 23 provided for returning the banknotes that are not subject to be stored in the money storage unit 40, among the banknotes respectively taken in the banknote handling machine 20, to the exterior of the banknote handling machine 20. Further, as shown in FIG. 3A, a transport unit 25 is provided in the banknote handling machine 20. This transport unit 25 is adapted for transporting the banknotes respectively inserted through the banknote inlet 21, in the banknote handling machine 20.

The banknote inlet 21 is configured such that one banknote or plurality of banknotes in a batch form can be collectively inserted therethrough, by the operator, in long-edge first orientation. Further, as shown in FIG. 2, a banknote stage 28 is provided to the banknote inlet 21. When in a waiting position, this banknote stage 28 is lifted to prevent the operator from inserting the banknotes through the banknote inlet 21. On the other hand, when handling the banknotes, the banknote stage 28 takes a lowered position for allowing the operator to insert the banknote through the banknote inlet 21. As shown in FIG. 3A, the banknote inlet 21 is connected to the transport unit 25, such that one banknote or plurality of banknotes in the batch form, inserted through the banknote inlet 21, can be transported, one by one, by the transport unit 25.

As shown in FIG. 3A, the banknote reject slot 22 is connected to the transport unit 25, such that each banknote that has been recognized to be rejected, by a recognition unit 26 (which will be described later), among the banknotes respectively taken in the banknote handling machine 20 via the banknote inlet 21, is transported to the banknote reject slot 22 from the transport unit 25. Thus, the operator can take out each banknote fed to the banknote reject slot 22. It should be noted that this banknote reject slot 22 can also serve as an outlet for dispensing change or the like. Additionally, a cover (not shown) is provided to the banknote reject slot 22. This cover is opened during the waiting time, while being closed when handling the banknotes or the like.

Further, as shown in FIG. 3A, a banknote holding unit 29 is provided to the banknote return slot 23, while being connected to the transport unit 25. This banknote holding unit 29 is configured to receive the banknotes transported by the transport unit 25. Further, a door 24 that can be optionally opened and closed is provided to the banknote return slot 23. When the banknotes held in the banknote holding unit 29 are returned, one side wall of the banknote holding unit 29 on the front face side of the banknote handling machine 20 is opened, thereby allowing the operator to take out the banknotes via the opened door 24. In this case, the door 24 is automatically opened, when the banknotes are brought into such a state that can allow the banknotes to be taken out from the banknote return slot 23. In some cases, as will be described later, rather than being taken out, by the operator, from the banknote return slot 23, the banknotes held in the banknote holding unit 29 are fed to a banknote storage cassette 41 (which will be described later) arranged in the banknote storage unit 40.

The transport unit 25 can serve to transport the banknotes, one by one, in succession, in the banknote handling machine 20. More specifically, the transport unit 25 is configured for transporting the banknotes along a transport path, while each banknote is held between a pair of belts. As shown in FIG. 3A, the transport path provided to the transport unit 25 is diverted at various points, with a diverter (not shown) provided at each diversion point of the transport path. For instance, each diverter is composed of a diverting nail, and is controlled by a control unit 15 that will be described later. Specifically, as shown in FIG. 3A, the transport unit 25 is provided for transporting each banknote inserted through the banknote inlet 21 to the banknote reject slot 22, banknote holding unit 29 or recycling banknote storage unit 27 that will be described later. Further, the transport unit 25 can serve to transport each banknote temporarily stored in the recycling banknote storage unit 27 to the banknote reject slot 22 and/or banknote holding unit 29.

Further, as shown in FIG. 3A, the recognition unit 26 is provided to the transport unit 25. The recognition unit 26 can serve to recognize the banknotes, one by one, while each banknote is transported by the transport unit 25. Specifically, this recognition unit 26 is configured for recognizing the denomination, authenticity, fitness or the like of each banknote transported by the transport unit 25. More specifically, the recognition unit 26 includes magnetic sensors and/or optical sensors, each adapted for recognizing the banknotes, one by one, about the denomination, authenticity or the like thereof. In this case, the recognition result on each banknote recognized by the recognition unit 26 will be transmitted to the control unit 15 that will be described later.

In this embodiment, a plurality of (e.g., three) recycling banknote storage units 27 are arranged, in parallel, in the banknote handling machine 20. In general, such recycling banknote storage units 27a to 27c are used for each denomination of the banknotes. For instance, in the case Japanese banknotes are handled by the banknote handling machine 20, one-thousand-yen banknotes, five-thousand-yen banknotes and ten-thousand-yen banknotes are stored in the recycling banknote storage units 27a to 27c, respectively. In some cases, two-thousand-yen banknotes and five-thousand-yen banknotes are stored, in a mixed state, in the recycling banknote storage unit 27b. Alternatively, in the case dollar banknotes (e.g., one-dollar banknotes, two-dollar banknotes, five-dollar banknotes, ten-dollar banknotes, twenty-dollar banknotes, fifty-dollar banknotes, one-hundred-dollar banknotes and the like) and/or yuan banknotes (e.g., one-yuan banknotes, five-yuan banknotes, ten-yuan banknotes, twenty-yuan banknotes, fifty-yuan banknotes, one-hundred-yuan banknotes and the like) are handled by the banknote handling machine 20, such currencies have more than three denominations respectively. Therefore, in this case, it is necessary to increase the number of the recycling banknote storage units 27 or otherwise to limit the denominations of the banknotes to be stored in the respective recycling banknote storage units 27. As shown in FIG. 3A, each recycling banknote storage unit 27 includes a drum 27p that can be rotated in both the forward and backward directions, with a pair of tapes being wound around each drum 27p. With this configuration, the banknotes fed to each recycling banknote storage unit 27 from the transport unit 25 will be wound around the drum 27p, one by one, while being held between the pair of tapes.

More specifically, each drum 27p is configured to be rotated in both the clockwise and anticlockwise directions in FIG. 3A, about an axis vertical to the sheet of FIG. 3A. Each end of the pair of tapes is attached at the same point on the outer circumferential face of each drum 27p. Thus, such a pair of tapes can be wound together around the drum 27p when the drum 27p is rotated in the anticlockwise direction in FIG. 3A. In this case, the operation of the drum 27p is controlled by the control unit 15 that will be described later. In this way, the banknotes fed to each recycling banknote storage unit 27 from the transport unit 25 can be wound, one by one, around each corresponding drum 27p, together with the pair of tapes, while being held between the pair or tapes, with the rotation of the drum 27p in the anticlockwise direction in FIG. 3A. Thus, a plurality of banknotes can be wound, one by one, around each corresponding drum 27p, with a proper interval. Meanwhile, when each drum 27p is rotated in the clockwise direction in FIG. 3A, the pair of tapes wound around this drum 27p will be released therefrom, and thus each banknote stored in each recycling banknote storage unit 27 will be fed to the transport unit 25.

It should be noted that each recycling banknote storage unit 27 is not limited to such an aspect as described above, in which this storage unit 27 is composed of the drum and pair of tapes, and each banknote can be wound around the drum, together with the pair of tapes, while being held therebetween. For instance, each recycling banknote storage unit 27 may be provided as a stacker-type storage unit.

As described above, the banknote holding unit 29 is provided in the banknote return slot 23, and connected to the transport unit 25, as shown in FIG. 3A. This banknote holding unit 29 is configured to receive the banknote inserted through the banknote inlet 21 and/or receive the banknote once stored in each recycling banknote storage unit 27 and then fed by the transport unit 25. Further, this banknote holding unit 29 can hold therein the plurality of banknotes, respectively fed from the transport unit 25, in the batch form. As described above, when the banknotes held in the banknote holding unit 29 are returned, the side wall of the banknote holding unit 29 on the front face side of the banknote handling machine 20 is opened, thereby allowing the operator to take out the banknotes via the door 24. In this case, the door 24 is automatically opened, once the banknotes are brought into the state that can allow the banknotes to be taken out from the banknote return slot 23. Meanwhile, when the banknotes are held in the banknote holding unit 29, the banknotes are placed on a temporary holding plate. Further, when the banknotes held in the banknote holding unit 29 are fed to and stored in the banknote storage cassette 41, a stage provided in the banknote storage cassette 41 is moved toward the banknotes placed on the temporary holding plate of the banknote holding unit 29, and then lowered toward the banknote storage cassette 41 from the banknote holding unit 29, with the banknotes transferred and placed on the stage. Thereafter, the banknotes are stored in the banknote storage cassette 41, while being pushed on the stage, from above, by a holding member.

Next, referring to FIGS. 2 and 3B, the construction of the coin handling machine 30 will be described. As shown in FIGS. 2 and 3B, the coin handling machine 30 includes a coin inlet 31 provided for taking the coins into the coin handling machine 30, and a coin return slot 32 provided for rejecting the coins that cannot be recognized by a recognition unit 35a that will be described later, among the coins respectively taken in the coin handling machine 30, as well as for returning the coins that are not subjected to be stored in the money storage unit 40, among the coins respectively taken in the coin handling machine 30, to the exterior of the coin handling machine 30. Further, as shown in FIG. 3B, a transport unit 35 is provided in the coin handling machine 30. This transport unit 35 is adapted for transporting the coins respectively inserted through the coin inlet 31, in the coin handling machine 30.

The coin inlet 31 is configured such that one or more coins can be collectively inserted therethrough. Then, the coins respectively inserted through the coin inlet 31 are fed to the interior of the coin handling machine 30.

The coin return slot 32 is connected to a downstream end of the transport unit 35, and is configured for accumulating therein the coins respectively transported from the transport unit 35. Thus, the operator can take out the coins accumulated in the coin return slot 32. As described above, this coin return slot 32 is provided for receiving the coins or the like that cannot be recognized by the recognition unit 35a, among the coins respectively taken in the coin handling machine 30, as well as for receiving the coins that are not subjected to be stored in the money storage unit 40, among the coins respectively taken in the coin handling machine 30. Thereafter, such coins will be returned to the exterior of the coin handling machine 30, via the coin return slot 32.

As shown in FIG. 3B, a coin feeding unit 33 is provided in the coin handling machine 30. This coin feeding unit 33 is communicated with the coin inlet 31, and is configured for temporarily accumulating therein the coins inserted by the operator through the coin inlet 31, as well as for feeding out such accumulated coins to the transport unit 35 that will be described later. In detail, a rotary disk (not shown) adapted for feeding out the coins is provided to the coin feeding unit 33, such that the coins can be fed out, one by one, due to the actuation of this rotary disk, toward the transport unit 35.

The transport unit 35 can serve to transport the coins, one by one, in succession, in the coin handling machine 30. More specifically, this transport unit 35 can transport the coins, one by one, by using a coin transport belt (not shown), while each coin is standing on the belt, in a slightly inclined state, with an appropriate interval. As shown in FIG. 3B, an upstream end and downstream end of the transport unit 35 are connected with the coin feeding unit 33 and coin return slot 32, respectively.

Further, as shown in FIG. 3B, the recognition unit 35a is provided to the transport unit 35. The recognition unit 35a can serve to recognize the coins, one by one, while each coin is transported by the transport unit 35. Specifically, this recognition unit 35a is configured for recognizing the denomination, authenticity or the like of each coin transported by the transport unit 35. More specifically, the recognition unit 35a includes magnetic sensors and/or optical sensors, each adapted for recognizing the coins, one by one, about the denomination, authenticity or the like thereof. In this case, the recognition result on each coin recognized by the recognition unit 35a will be transmitted to the control unit 15 that will be described later.

In this embodiment, a plurality of (e.g., six) cylindrical recycling coin storage units 34 are arranged, in parallel, in the coin handling machine 30, wherein each recycling coin storage unit 34 is configured for taking in and taking out the coins from the top thereof. Further, each recycling coin storage unit 34 is provided to extend in the vertical direction in the coin handling machine 30. In general, such recycling banknote storage units 34a to 34f are used for each denomination of the coins. For instance, in the case Japanese coins are handled by the coin handling machine 30, one-yen coins, five-yen coins, ten-yen coins, fifty-yen coins, one-hundred-yen coins and five-hundred-yen coins are stored in the recycling coin storage units 34a to 34f, respectively. Alternatively, in the case US coins (e.g., one-cent coins, five-cent coins, ten-cent coins, twenty-five cent coins, fifty-cent coins, one-dollar coins and the like) and/or Chinese coins (e.g., one-fen coins, two-fen coins, five-fen coins, one-jiao coins, five-jiao coins, one-yuan coins and the like) are handled by the coin handling machine 30, the recycling coin storage units 34 will be provided, corresponding to the denominations of such currency. In any case, the coins are stored, in a stacked condition, in each recycling coin storage unit 34.

As shown in FIG. 3B, seven sorting holes 36 are provided, in a middle part of the transport unit 35 extending from the coin feeding unit 33 toward the downstream side of the transport unit 35, while being arranged with a given interval. In this case, the sorting hole 36 (or overflow sorting hole 36) located on the most upstream side, among the seven sorting holes 36, is provided for feeding the coins, directly, from the transport unit 35, to a lateral transport unit 38 that will be described later. More specifically, the sorting hole 36 located on the most upstream side can serve to feed the coins, directly, onto the lateral transport unit 38, when the recognition result on the coins recognized by the recognition unit 35a satisfies a predetermined condition (e.g., when a certain recycling coin storage unit 34 corresponding to the denomination of the coins recognized by the recognition unit 35a is completely filled with the coins). Meanwhile, each of the second to seventh sorting holes 36, respectively arranged from the upstream side, is provided, corresponding to each of the recycling coin storage units 34a to 34f.

As shown in FIG. 3B, a coin escrow unit 39 for each denomination, which is adapted for escrowing (or temporarily holding) therein the coins, is provided to a top portion of each recycling coin storage unit 34 extending in the vertical direction. With this configuration, the coins, respectively falling down from the transport unit 35 through each sorting hole 36, are first escrowed in the coin escrow unit 39. In this case, the coin escrow unit 39 is configured for escrowing therein approximately ten coins, for each denomination of the coins. Thereafter, the coins respectively escrowed in this coin escrow unit 39 will be stored in each corresponding recycling coin storage unit 34. Further, the coin escrow unit 39 includes a releasing member. Namely, due to the actuation of this releasing member, the coins respectively escrowed in the coin escrow unit 39, for each denomination thereof, can be released onto the lateral transport unit 38 that will be described later.

Meanwhile, in the case the coins stored in each corresponding recycling coin storage unit 34 are taken out therefrom, a stage (not shown) provided at a bottom portion of the recycling coin storage unit 34 is lifted upward, and then the coins placed on the stage are fed toward the coin escrow unit 39 for each denomination. Thereafter, such coins fed to the coin escrow unit 39 are released onto the lateral transport unit 38 by the releasing member of the coin escrow unit 39.

Further, as shown in FIG. 3B, a coin holding unit 37a is provided in the coin handling machine 30, with a chute 37b provided above the coin holding unit 37a. With this configuration, the coins fed to a top portion of the chute 37b from the lateral transport unit 38 that will be described later can be fed to the coin holding unit 37a through the chute 37b. Thereafter, the coins temporarily held in the coin holding unit 37a can be fed to a coin storage cassette 42 (that will be described later) located in the money storage unit 40.

Additionally, in the coin handling machine 30, as shown in FIG. 3B, the lateral transport unit 38 having, for example, a circulating belt 38a extending in a substantially horizontal direction, is provided in the vicinity of the recycling coin storage units 34 respectively extending in the vertical direction. The circulating belt 38a is provided with two pulleys, each positioned at the same level. As such, the circulating belt 38a can be circulated in both the clockwise and anticlockwise directions in FIG. 3B, with the rotation of one of the two pulleys in both the forward and backward directions. One end of the lateral transport unit 38 is positioned in the coin feeding unit 33, while the other end of the lateral transport unit 38 is positioned in the vicinity of the top portion of the chute 37b. As described above, the circulating belt 38a of the lateral transport unit 38 can be rotated in both the forward and backward directions. Therefore, when the circulating belt 38a is rotated in the anticlockwise direction in FIG. 3B, the coins present on the lateral transport unit 38 can be fed to the coin feeding unit 33. Meanwhile, when the circulating belt 38a is rotated in the clockwise direction in FIG. 3B, the coins present on the lateral transport unit 38 can be fed to the chute 37b, and thus eventually held in the coin holding unit 37a.

Next, other various mechanisms provided in the money handling machine 10 will be described. As shown in FIG. 2, an operation unit 45 adapted for allowing the operator to input various commands to the control unit 15 (that will be described later) of the money handling machine 10, and a display unit 44 adapted for displaying thereon contents or the like of handling the money in the money handling machine 10 are respectively provided to a top face of the casing 11 of the money handling machine 10. The operation unit 45 includes, for example, numeric keys, a confirmation key, a start key, a clear (or cancelling) key, a reset key and the like. Thus, by pushing such keys, the operator can input the various commands to the control unit 15 of the money handling machine 10. The display unit 44 is composed of, for example, a liquid crystal display (LCD) device.

Further, a printer 43 adapted for printing the contents or the like of handling the money in the money handling machine 10, and a card reader 46 adapted for checking the authority of the operator to operate the money handling machine 10 are respectively provided to a front face of the casing 11.

In addition, as shown in FIG. 2 and other related drawings, the money storage unit 40 is provided to a bottom portion of the casing 11 of the money handling machine 10. The money storage unit 40 includes the banknote storage cassette 41 adapted for storing therein the banknotes and the coin storage cassette 42 adapted for storing therein the coins. Namely, the banknote storage cassette 41 is configured for storing therein the banknotes once held in the banknote holding unit 29 of the banknote handling machine 20, and the coin storage cassette 42 is configured for storing therein the coins once held in the coin holding unit 37a of the coin handling machine 30. With this configuration, each of the cassettes 41, 42 of the money storage unit 40 can be drawn out, forward, from the casing 11, by the designated collector, such as the staff or the like of the armored car company, entrusted to collect the money from sale. In this manner, each cassette 41, 42, itself, can be collected by the designated collector.

In this case, as described above, the banknote handling machine 20 and/or coin handling machine 30 is arranged to be controlled under the control authority provided on the side of the store. On the other hand, the money storage unit 40 is arranged to be controlled under the control authority provided on the side of the designated collector. Therefore, various processes for handling the banknotes and/or coins respectively stored in the recycling banknote storage units 27 of the banknote handling machine 20 and/or recycling coin storage units 34 of the coin handling machine 30, and/or access to the information on the deposit/dispense and/or data of total amount of the banknotes and/or coins can be performed by only the authorized operator on the side of the store. Meanwhile, the collection of the banknotes and/or coins stored in the money storage unit 40 can be performed by only the designated collector.

Now, referring to FIG. 4, the control unit 15 adapted for controlling each component of the money handling machine 10 will be described. This control unit 15 is provided in the casing 11 of the money handling machine 10.

As shown in FIG. 4, the control unit 15 is connected with each of the components of the banknote handling machine 20 (e.g., the transport unit 25, recognition unit 26, recycling banknote storage units 27, banknote stage 28, banknote holding unit 29, door 24 and the like) and each of the components of the coin handling machine 30 (e.g., the coin feeding unit 33, transport unit 35, recognition unit 35a, lateral transport unit 38, recycling coin storage units 34 including the coin escrow unit 39 for each denomination, coin holding unit 37a and the like), as well as connected with the money storage unit 40, display unit 44, operation unit 45, printer 43, card reader 46 and the like. Further, the control unit 15 is connected with the controller 12 (17) via an interface.

The control unit 15 is configured for receiving the recognition result on each banknote recognized by the recognition unit 26 of the banknote handling machine 20, as well as for receiving the recognition result on each coin recognized by the recognition unit 35a of the coin handling machine 30. Further, the control unit 15 is configured for receiving the information on the ID information or the like of the operator, inputted from the operation unit 45 or read by the card reader 46 from each card. When the money handling machine 10 is operated, the control unit 15 checks the authority of the operator, based on the ID information of the operator inputted from the operation unit 45 and/or card reader 46. Alternatively, this authority may be checked, based on the authority provided to each card itself. Further, the control unit can serve to control each component of the banknote handling machine 20 and/or coin handling machine 30, as well as to control the display unit 44, printer 43 and the like.

The controller 12 (17) is configured to transmit and receive a signal to and from each of the banknote handling machine 20, coin handling machine 30 and money storage unit 40 of the money handling machine 10. This transmission and/or reception of the signal can be performed via the control unit 15.

The cash center 13 or data center 14, each constituting the central control unit, is configured to transmit a command signal indicative of each process to be performed by the money handling machine 10, to the money handling machine 10, via the controller 12 (17). More specifically, the signal transmitted from the cash center 13 to the money handling machine 10 is related to at least one of a closing command, a delivery command, a delivery-with-closing command, a collection by staff command, a depositing command, a dispensing command, a supplement command, a checking command, an exchange from large denomination to small denomination command, an exchange from small denomination to large denomination command, a counting command, a reset command, a confirmation command, a start command, an unlocking command and a program download command. Such commands will be further described below.

Further, the cash center 13 or data center 14, each constituting the central control unit, is configured to receive a signal indicative of information on the condition of the money handled by the money handling machine 10, from the money handling machine 10, via the controller 12 (17). More specifically, the signal received by the data center 14 from the money handling machine 10 is related to at least one of the closing data, delivery data, collection by staff data, amount of money data of the recycling money storage unit, depositing data, dispensing data, supplement data, checking data, exchange from large denomination to small denomination data, exchange from small denomination to large denomination data, counting data, amount of money data, system data, failure data and program data. Such data will be further described below.

Next, the operation of the money handling machine 10 constructed as described above will be discussed.

The operation of the money handling machine 10 includes three modes, i.e., an interface confirmation mode, an operation mode and a maintenance mode. In this embodiment, the operator can optionally select each of the interface confirmation mode, operation mode and maintenance mode via the operation unit 45.

The interface confirmation mode is provided for checking whether or not the money handling machine 10 is connected with a higher-ranking machine or the like via the interface 16, in an initial state of the money handling machine 10 or when installing the money handling machine 10. In this interface confirmation mode, when the money handling machine 10 is connected, for communication, with the higher-ranking machine or the like via the interface 16, various setting data can be transmitted to the money handling machine 10 from the higher-ranking machine or the like.

The operation mode includes two modes, i.e., an on-line mode in which the money handling machine 10 is connected, for communication, with the higher-ranking machine or the like, and an off-line mode in which the connection for the communication between the money handling machine 10 and any external machine is shut off. Further, the on-line mode includes two modes, i.e., an opening-store mode and a closing-store mode. In the opening-store mode, the operator can perform the supplement process, depositing process, dispensing process, delivery process, mass delivery process, exchange from large denomination to small denomination process, exchange from small denomination to large denomination process, checking process, counting process, closing process, delivery-with-closing process and the like. Further, in the opening-store mode, each cassette 41, 42, itself, of the money storage unit 40 can be collected by the designated collector, such as the staff or the like of the armored car company, entrusted to collect the money from sale or the like (this process is herein referred to as the “collection by staff process”). Meanwhile, in the closing-store mode, only the collection of each cassette 41, 42 of the money storage unit 40 can be performed by the designated collector. If required, such opening-store mode and closing-store mode may be switched from each other for specific time periods. Meanwhile, in the off-line mode, no information is transmitted to and from the higher-ranking machine, and the result of each process, e.g., the depositing process or the like, is stored in a proper memory (not shown) provided in the money handling machine 10. It is noted that the operator can optionally select each of the modes via the operation unit 45.

During the maintenance mode, a person in charge of maintenance for the money handling machine 10 performs maintenance of the money handling machine 20 and/or coin handling machine 30 of the money handling machine 10. Such maintenance may be carried out in a site or place where the money handling machine 10 is installed, or otherwise may be conducted after the money handling machine 10 is carried to a factory or the like.

Now, the supplement process, depositing process, dispensing process, delivery process, mass delivery process, exchange from large denomination to small denomination process, exchange from small denomination to large denomination process, checking process, counting process, closing process, delivery-with-closing process and collection by staff process will be described, respectively. Each of these processes is performed by actuation of each component controlled by the control unit 15. Further, each of the supplement process, depositing process, dispensing process, delivery process, mass delivery process, exchange from large denomination to small denomination process, exchange from small denomination to large denomination process, checking process, counting process, closing process, delivery-with-closing process and collection by staff process is performed, based on each corresponding command inputted to the control unit 15 by the operator via the operation unit 45, or otherwise performed, based on each corresponding command given to the control unit 15, via the controller 12 (17), from the cash center 13 or data center 14.

### (Supplement Process)

First of all, the supplement process for the banknotes and/or coins will be described in brief. The supplement process for the banknotes and/or coins is provided for supplementing each recycling banknote storage unit 27 of the banknote handling machine 20 with the banknotes for each denomination and/or supplementing each recycling coin storage unit 34 of the coin handling machine 30 with the coins for each denomination.

### (Depositing Process)

Next, the depositing process for the banknotes and/or coins will be described in brief. This depositing process includes two modes, i.e., a mode with the delivery process and another mode without the delivery process. The depositing process in the mode with the delivery process is provided for depositing the money into the money handling machine 10, with the delivery process performed directly in succession to the depositing process. More specifically, in this mode, the banknotes are temporarily held or stored in each corresponding recycling banknote storage unit 27, and then held in the banknote holding unit 29, and finally stored in the banknote storage cassette 41. Further, in this mode, the coins are escrowed or temporarily held in the coin escrow unit 39 for each denomination, and then held in the coin holding unit 37a, and finally stored in the coin storage cassette 42. Meanwhile, the depositing process in the mode without the delivery process is provided for only depositing the money into the money handling machine. Namely, in this mode, if required, the delivery process (that will be described later) for the money to the money storage unit 40 is performed, independently, after the depositing process. In this embodiment, the mode with delivery process or mode without delivery process can be optionally set during the installment of the money handling machine 10.

### (Dispensing Process)

Next, the dispensing process for the banknotes and/or coins will be described in brief. The dispensing process for the banknotes and/or coins is provided for dispensing the banknotes stored in each recycling banknote storage unit 27 of the banknote handling machine 20 to the exterior of the banknote handling machine 20, and/or dispensing the coins stored in each recycling coin storage unit 34 of the coin handling machine 30 to the exterior of the coin handling machine 30.

### (Delivery Process)

Next, the delivery process for the banknotes and/or coins will be described. Herein, the delivery process for the banknotes and/or coins is provided for delivering the banknotes stored in each recycling banknote storage unit 27 of the banknote handling machine 20 to the banknote storage cassette 41 of the money storage unit 40, and/or delivering the coins stored in each recycling coin storage unit 34 of the coin handling machine 30 to the coin storage cassette 42 of the money storage unit 40. When the delivery process is performed, the authority, under which the banknotes and/or coins, respectively fed from each recycling banknote storage unit 27 and/or each recycling coin storage unit 34 to the coin storage unit 40, are controlled, will be changed from the first control authority to the second control authority. As a result, the amount of money of the banknotes and/or coins, respectively stored in each recycling banknote storage unit 27 and/or each recycling coin storage unit 34 is reduced by the amount of money of the banknotes and/or coins respectively subjected to the delivery process. Meanwhile, the amount of money of the banknotes and/or coins, respectively stored in the banknote storage cassette 41 and/or coin storage cassette 42 of the money storage unit 40, is increased by the amount of money of the banknotes and/or coins respectively subjected to the delivery process.

Now, referring to FIGS. 5A and 5B, the delivery process for the banknotes in the banknote handling machine 20 will be further described. In the case of the depositing process in the mode with the delivery process, the banknotes deposited and stored in each recycling banknote storage unit 27 are fed to and held in the banknote holding unit 29, without any operation by the operator (see FIG. 5A). Thereafter, once the “confirmation key” provided in the operation unit 45 is pushed, the banknotes respectively held in the banknote holding unit 29 will be stored in the banknote storage cassette 41, and thus the delivery process is completed (see FIG. 5A). Meanwhile, in the mode of the depositing process without the delivery process, the banknotes stored in each recycling banknote unit 27 are fed to and held in the banknote holding unit 29, in a predetermined amount of money, (e.g., the amount of money calculated by subtracting the amount of money of the banknotes desired to be left as change in the respective recycling banknote units 27, from the amount of money of the banknotes once stored therein) (see FIG. 5A). Thereafter, when the confirmation key is pushed at the operation unit 45, the banknotes held in the banknote holding unit 29 will be stored in the banknote storage cassette 41, and thus the delivery process is completed (see FIG. 5B). As described above, either of the depositing process in the mode with the delivery process and the depositing process without the delivery process is optionally set, in advance.

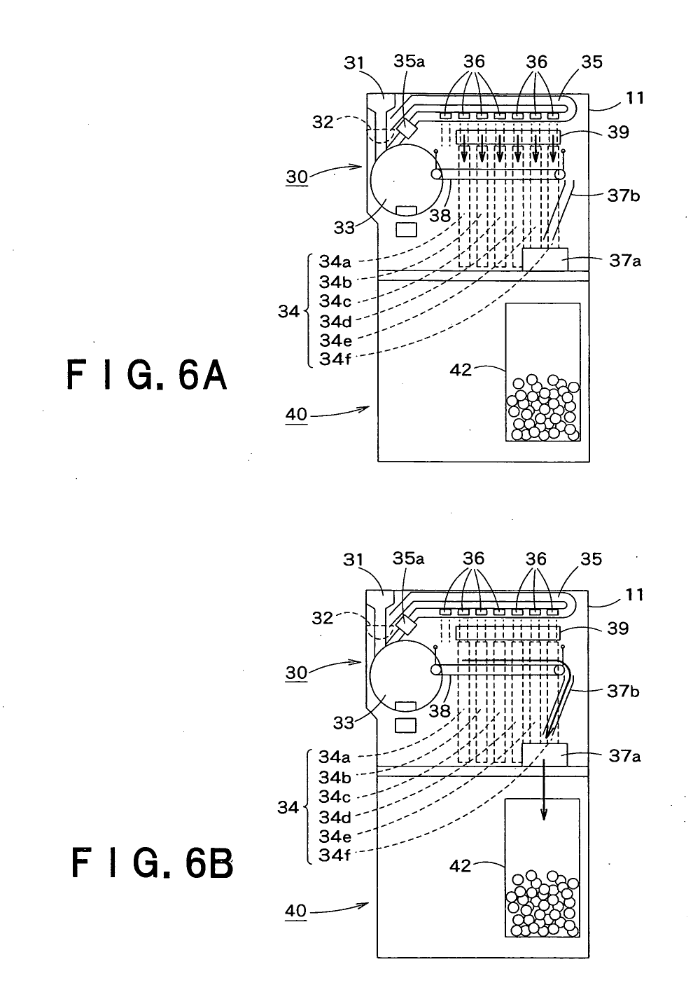

Next, referring to FIGS. 6A and 6B, the delivery process for the coins in the coin handling machine 30 will be described. In the case of the depositing process in the mode with the delivery process, the coins deposited and stored in each recycling coin storage unit 34 are fed to the coin escrow unit 39 for each denomination, without any operation by the operator, and then fed to the lateral transport unit 38 from the coin escrow unit 39 (see FIG. 6A). Thereafter, such coins are fed to and held in the coin holding unit 37a, via the chute 37b, from the lateral transport unit 38. At this point of time, when the “confirmation key” provided in the operation unit 45 is pushed, the coins respectively held in the coin holding unit 37a will be stored in the coin storage cassette 42, and thus the delivery process is completed (see FIG. 6B). Meanwhile, in the case of the depositing process in the mode without the delivery process, the coins stored in each recycling coin unit 34 are fed to and escrowed in the coin escrow unit 39 for each denomination, in a predetermined amount of money, (e.g., the amount of money calculated by subtracting the amount of money of the coins desired to be left as change in the respective recycling coin units 34, from the amount of money of the coins once stored therein). Thereafter, the coins are fed to the lateral transport unit 38 from the coin escrow unit 39 for each denomination (see FIG. 6A), and then fed to and held in the coin holding unit 37a, via the chute 37b, from the lateral transport unit 38. Thereafter, when the confirmation key is pushed at the operation unit 45, the coins held in the coin holding unit 37a will be stored in the coin storage cassette 42, and thus the delivery process is completed (see FIG. 6B). As described above, either of the depositing process in the mode with the delivery process and the depositing process without the delivery process can optionally be set, in advance, in the money handling machine.

### (Mass Delivery Process)

Now, the mass delivery process for the banknotes and/or coins will be described. Herein, the mass delivery process for the banknotes and/or coins is provided for delivering the banknotes, in a relatively large amount, to the banknote storage cassette 41 of the money storage unit 40, and/or delivering the coins, in a relatively large amount, to the coin storage cassette 42 of the money storage unit 40.

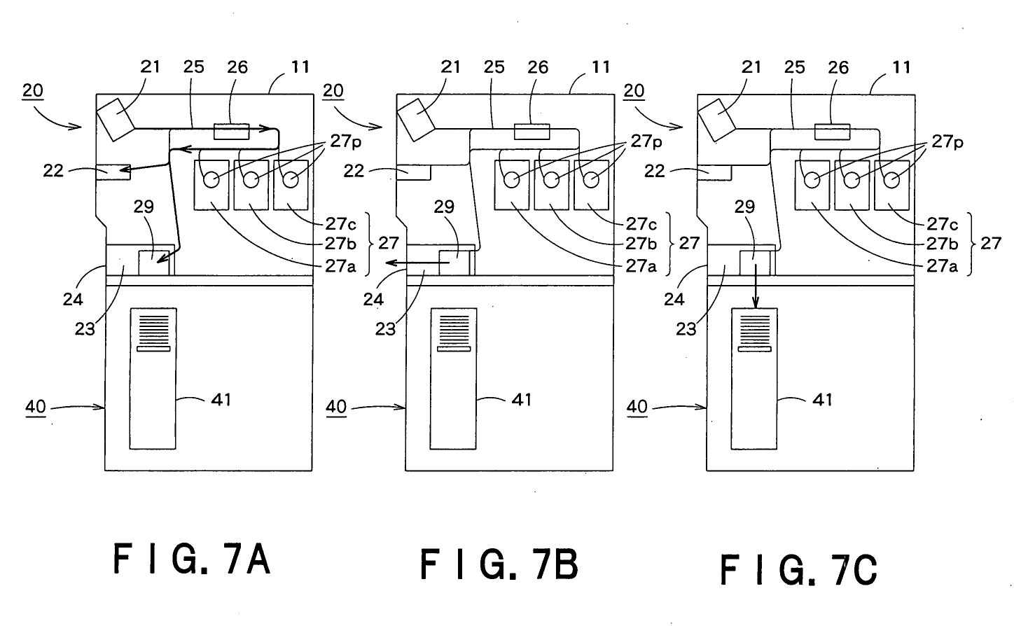

First, the mass delivery process for the banknotes in the banknote handling machine 20 will be discussed, with reference to FIGS. 7A through 7C. When the command for the mass delivery process is inputted to the control unit 15 and then the banknotes are inserted by the operator through the banknote inlet 21 of the banknote handling machine 20, such banknotes inserted through the banknote inlet 21 are transported, one by one, by the transport unit 25, and then recognized by the recognition unit 26. If the banknote is recognized, as a normal banknote, by the recognition unit 26, this banknote will be fed to the banknote holding unit 29 by the transport unit 25, as shown in FIG. 7A. Meanwhile, if the banknote is recognized, as a rejected banknote, such as the counterfeit banknote, unfit banknote or the like, by the recognition unit 26, this banknote will be fed to the banknote reject slot 22 by the transport unit 25, as shown in FIG. 7A. During such processes, as respectively described above and illustrated in FIG. 7A, the banknotes are also counted by the recognition unit 26.

Once such processes as described above are performed and if the operator pushes the “confirmation key” provided in the operation unit 45, the banknotes held in the banknote holding unit 29 will be fed to the banknote storage cassette 41 of the money storage unit 40, as shown in FIG. 7C.

Meanwhile, once the processes as described above are performed and if the operator pushes the “clear key” provided in the operation unit 45 in order to send the command for cancelling the depositing process to the control unit 15, the door 24 will be automatically opened, for allowing the operator to take out the banknotes held in the banknote holding unit 29, as shown in FIG. 7B.

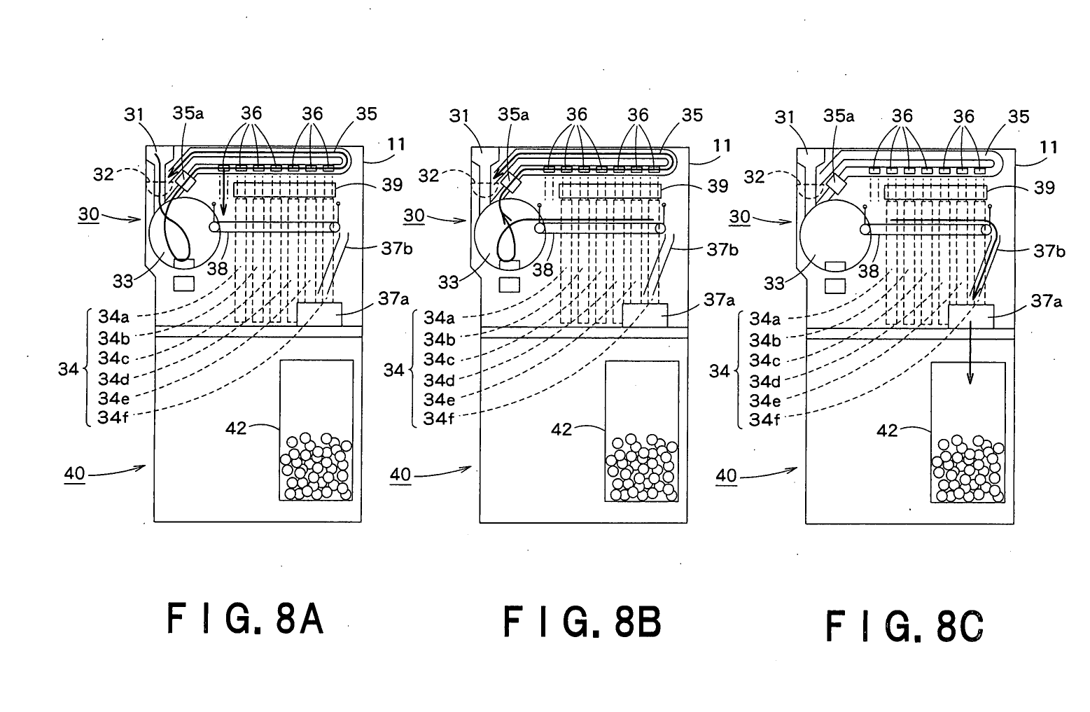

Next, the mass delivery process for the coins in the coin handling machine 30 will be described, with reference to FIGS. 8A through 8C. When the command for the mass delivery process is inputted to the control unit 15 and then the coins are inserted by the operator through the coin inlet 31 of the coin handling machine 30, such coins are first transported to the coin feeding unit 33, and then fed out to the transport unit 35, one by one. Thereafter, the coins fed to the transport unit 35 are recognized by the recognition unit 35a. If the coin is recognized, as a normal coin, by the recognition unit 35a, this coin will be fed onto the lateral transport unit 38, via the sorting hole 36 provided on the most upstream side of the transport unit 35a, as shown in FIG. 8A. Meanwhile, if the coin is recognized, as a rejected coin, such as the coin or the like that cannot be recognized by the recognition unit 35a, this coin will be fed to the coin return slot 32 by the transport unit 35, as shown in FIG. 8A. During such processes, as respectively described above and illustrated in FIG. 8A, the coins are also counted by the recognition unit 35a.

Once such processes as described above are performed and if the operator pushes the “confirmation key” provided in the operation unit 45, the coins present on the lateral transport unit 38 will be fed to the chute 37b from the lateral transport unit 38, and then fed to the coin holding unit 37a from the chute 37b, as shown in FIG. 8C. Thereafter, the coins fed to the coin holding unit 37a will be finally fed to the coin storage cassette 42 of the money storage unit 40.

Meanwhile, once the processes as described above are performed and if the operator pushes the “clear key” provided in the operation unit 45 in order to send the command for cancelling the depositing process to the control unit 15, the coins present on the lateral transport unit 38 will be fed to the coin feeding unit 33, and then fed to the coin return slot 32, via the transport unit 35, from the coin feeding unit 33, as shown in FIG. 8B.

(Exchange from Large Denomination to Small Denomination Process, and Exchange from Small Denomination to Large Denomination Process) Next, the exchange from large denomination to small denomination process and the exchange from small denomination to large denomination process will be described in brief. Herein, the exchange from large denomination to small denomination process and the exchange from small denomination to large denomination process are respectively provided for once taking the banknotes and/or coins into the banknote handling machine 20 and/or coin handling machine 30, and then returning the banknotes and/or coins, the amount of money of which is the same as the amount of money of the banknotes and/or coins once taken in the banknote handling machine 20 and/or coin handling machine 30, while being different in the denomination or denominations of money therefrom, to the exterior of the banknote handling machine 20 and/or coin handling machine 30.

### (Checking Process)

Now, the checking process for the banknotes and/or coins will be described in brief. This checking process for the banknotes is provided for first counting the banknotes present in the banknote handling machine 20, and then ejecting such counted banknotes through the banknote reject slot 22 in order to check the number and/or amount of money of such ejected banknotes, and finally depositing again such checked banknotes. Meanwhile, the checking process for the coins includes two checking modes, i.e., a normal checking mode and an automatic checking mode. The normal checking mode for the coins is provided for first counting the coins present in the coin handling machine 30, and then ejecting such counted coins through the coin return slot 32 in order to check the number and/or amount of money of such ejected coins, and finally depositing again such checked coins. On the other hand, the automatic checking mode is provided for once feeding the coins present in each recycling coin storage unit 34 onto the lateral transport unit 38, and then feeding out the coins from the coin feeding unit 33 and transporting them by the transport unit 35, and finally returning the coins to each recycling coin storage unit 34 via the escrow unit 39 for each denomination. In this case, the operator can optionally select either of the former (or normal) checking mode or latter (or automatic) checking mode, in the checking process for the coins, by using the operation unit 45, while watching the display unit 44.

### (Counting Process)

Next, the counting process for the banknotes and/or coins will be described in brief. The counting process for the banknotes and/or coins is provided for counting the banknotes and/or coins at hand. More specifically, the counting process for the banknotes is provided for first feeding the banknotes into the banknote handling machine 20, and then temporarily holding the normal banknotes in the banknote holding unit 29, while feeding abnormal banknotes to the banknote reject slot 22 in order to reject them, and further counting the banknotes during such operations, and finally operating the door 24 to be automatically opened, thereby allowing the operator to take out the banknotes present in the banknote holding unit 29. Meanwhile, the counting process for the coins is provided for first feeding the coins into the coin handling machine 30, and then feeding the normal coins to the lateral transport unit 38 through the overflow sorting hole 36, while feeding abnormal coins to the coin return slot 32 in order to remove such rejected coins, and after removing the rejected coins, feeding the coins fed to the lateral transport unit 38 to the coin return slot 32, through the coin feeding unit 33 and transport unit 35, thereby allowing the operator to take out the coins finally fed to the coin return slot 32.

### (Closing Operation)

Next, the closing operation will be described in brief.

When the closing command is inputted from the operator to the control unit 15, via the operation unit 45, or when the closing command is sent to the control unit 15 from the cash center 13 or data center 14, via the controller 12 (17), the closing data, which is the data on the number of money for each denomination thereof or data on the total amount of money or amount of money for each denomination thereof, will be calculated, in regard to the banknotes stored in the banknote storage cassette 41 and the coins stored in the coin storage cassette 42, due to the delivery process performed, in the predetermined period of time, e.g., during the period of time from the previous closing process to the present closing process. Thereafter, the so-obtained closing data will be transmitted to the central control unit.

### (Delivery-with-Closing Process)

Next, the delivery-with-closing process will be described. When the delivery-with-closing command is given to the control unit 15, by the operator, via the operation unit 45, or when the delivery-with-closing command is sent to the control unit 15 from the cash center 13 or data center 14, via the controller 12 (17), the delivery process as described above is first performed, and then the closing process as described above is automatically performed, in succession, after the delivery process is ended.

In this case, when the information on the amount of money regarding the closing process is sent, together with the delivery-with-closing command as described above, to the control unit 15, the control unit 15 will subtract the amount of money of the banknotes and/or coins, respectively subjected to the delivery process, in the predetermined period of time, e.g., during the period of time from the previous closing process to the present closing process, before this delivery-with-closing command is sent to the control unit 15, from the amount of money regarding the closing process in the received information, and then perform the delivery process, based on the resultant amount of money. Then, after this delivery process is performed, the closing process as described above is automatically performed in succession thereto.

Alternatively, when the information on the amount of money to be delivered is sent, together with the delivery-with-closing command as described above, to the control unit 15, the money will be subjected to the delivery process, based on this amount of money to be delivered in the received information. Then, the closing process as described above will be automatically performed in succession to the end of this delivery process.

Alternatively, when the information on the amount of money to be left or information on the number of money to be left for each denomination thereof is sent, together with the delivery-with-closing command as described above, to the control unit 15, the control unit 15 will allow the banknotes and/or coins, respectively corresponding to the amount of money to be left or number of money to be left for each denomination thereof in the received information, to be left in each recycling banknote storage unit 27 of the banknote handling machine 20 and/or each recycling coin storage unit 34 of the coin handling machine 30, while allowing the surplus banknotes and/or coins to be subjected to the delivery process. Then, after this delivery process is ended, the closing process as described above is automatically performed in succession thereto.

Alternatively, in the case only the delivery-with-closing command is sent to the control unit 15, while the information related to the amount of money regarding the closing process, amount of money to be delivered or amount of money to be left is not given to the control unit 15, the control unit 15 will allow the banknotes and/or coins, respectively corresponding to a preset amount of money or preset number of money for each denomination, to be left in each recycling banknote storage unit 27 of the banknote storage unit 20 and/or each recycling coin storage unit 34 of the coin storage unit 30, while allowing the surplus banknotes and/or coins to be subjected to the delivery process. Then, after this delivery process is ended, the closing process as described above is automatically performed in succession thereto.

Alternatively, in the case the total amount of the banknotes and/or coins, respectively stored in each recycling banknote storage unit 27 of the banknote handling machine 20 and/or each recycling coin storage unit 34 of the coin handling machine 30, reaches a predetermined amount, the control unit 15 may perform the delivery process until the amount of such banknotes and/or coins, respectively stored in each recycling banknote storage unit 27 and/or each recycling coin storage unit 34, reaches a preset storage amount, which is less than the predetermined amount, and then perform the closing process as described above, in succession, after this delivery process is ended. As used herein, the “predetermined amount” means a full amount or nearly full amount in each of the recycling banknote storage units 27 and/or recycling coin storage units 34.

### (Collection by Staff Process)

Next, the collection by staff process will be described in brief. When the command for the collection by staff process is sent to the control unit 15, the control unit 15 will unlock a door of the money storage unit 40, thereby to allow the banknote storage cassette 41 and coin storage cassette 42 to be respectively taken out from the money storage unit 40. In this state, the staff of the armored car company or the like being present on the side of the designated collector can take out each of the cassettes, while exchanging them with new cassettes. Thereafter, once the collecting staff or the like closes the door, the collection by staff data, which is the data on the number of money for each denomination thereof or data on the amount of money or amount of money for each denomination thereof, in regard to the collected banknotes and/or coins, will be transmitted to the central control unit.

Each of the above processes, except for the delivery process included in the depositing process in the mode with the delivery process, is started, when the operator selects one of such processes, inputs the command necessary for the process via the operation unit 45, and then pushes the start key. Further, in the case of the supplement process or depositing process, if the confirmation key is pushed down during a predetermined period of time in which the clear key is allowed to be pushed down, the process will be completed after being confirmed.

Alternatively, as described above, the cash center 13 or data center 14 can transmit at least one of the closing command, delivery command, delivery-with-closing command, collection by staff command, depositing command, dispensing command, supplement command, checking command, exchange from large denomination to small denomination command, exchange from small denomination to large denomination command, counting command, reset command, confirmation command, start command, unlocking command and program download command, to the money handling machine 10. Such commands are respectively provided as an alternative of the operation of the operation unit 45 for each corresponding process.

More specifically, the “closing command” means herein a command for operating the money handling machine 10 to perform the closing process as described above, and the “delivery command” means a command for operating the money handling machine 10 to perform the delivery process as described above. The “delivery-with-closing command” refers to a command for operating the money handling machine 10 to perform the delivery-with-closing process as described above, and the “collection by staff command” means a command for operating the money handling machine 10 to perform the collection by staff process as described above.

Further, as used herein, the “depositing command” means a command for operating the money handling machine 10 to perform the depositing process as described above, and the “dispensing command” refers to a command for operating the money handling machine 10 to perform the dispensing process as described above. The “supplement command” refers to a command for operating the money handling machine 10 to perform the supplement process as described above, and the “checking command” means a command for operating the money handling machine 10 to perform the checking process as described above.

In addition, the “exchange from large denomination to small denomination command” herein refers to a command for operating the money handling machine 10 to perform the exchange from large denomination to small denomination process as described above, and the “exchange from small denomination to large denomination command” means a command for operating the money handling machine 10 to perform the exchange from small denomination to large denomination process as described above. Further, the “counting command” means a command for operating the money handling machine 10 to perform the counting process as described above. As used herein, the “reset command” refers to a command for operating the money handling machine. 10 to perform an operation that can provide the same effect as that obtained by pushing the reset key of the operation unit 45, and the “confirmation command” means a command for operating the money handling machine 10 to perform an operation that can provide the same effect as that obtained by pushing the confirmation key of the operation unit 45. Further, the “start command” means a command for operating the money handling machine 10 to perform an operation that can provide the same effect as that obtained by pushing the start key of the operation unit 45, the “unlocking command” means a command for unlocking the money handling machine 10, and the “program download command” refers to a command for downloading each program stored in the memory of the cash center 13 or data center 14 to the control unit 15. In this manner, with the remote control of the money handling machine 10 from the cash center 13 or data center 14, the deposit/dispense system can be operated, without the need for any authorized operator being always present in the store.

Meanwhile, the money handling machine 10 is configured to transmit the signal related to at least one of the closing data, delivery data, collection by staff data, amount of money data of the recycling money storage unit, depositing data, dispensing data, supplement data, checking data, exchange from large denomination to small denomination data, exchange from small denomination to large denomination data, counting data, amount of money data, system data, failure data and program data, to the cash center 13 or data center 14.

As used herein, the “closing data” refers to the data or information on the quantity (i.e., the number and amount) or the like of money for each denomination thereof, in regard to the banknotes and/or coins, respectively stored in the money storage unit 40 of the money handling machine 10, by the delivery process performed by the money handling machine 10, during the period of time from the previous closing process to the present closing process. The “delivery data” means the information on the quantity or the like of money for each denomination thereof, in regard to the banknotes and/or coins, respectively delivered from the banknote handling machine 20 and/or coin handling machine 30 to the money storage unit 40, by the delivery process performed by the money handling machine 10. Namely, this “delivery data” refers to the information on the quantity or the like of money for each denomination thereof, in regard to the banknotes and/or coins, respectively changed from a position to be controlled under the first control authority to another position to be controlled under the second control authority. Further, the “collection by staff data” means the information on the quantity or the like of money for each denomination thereof, in regard to the banknotes and/or coins, respectively present in the banknote storage cassette 41 and/or coin storage cassette 42, respectively collected from the coin storage unit 40, by the designated collector.

As used herein, the “amount of money data of the recycling money storage unit” means the data or information on the amount of money (i.e., the quantity of money for each denomination thereof), in regard to the banknotes temporarily stored in the recycling banknote storage units 27 of the banknote handling machine 20 and/or coins temporarily stored in the recycling coin storage units 34 of the coin handling machine 30. The “depositing data” means herein the information on the quantity or the like of money for each denomination thereof, in regard to the banknotes and/or coins, respectively subjected to the depositing process in the money handling machine 10, and the “dispensing data” means herein the information on the quantity, or the like of money for each denomination thereof, in regard to the banknotes and/or coins, respectively subjected to the dispensing process in the money handling machine 10. Further, the “supplement data” as used herein refers to the information on the quantity or the like of money for each denomination thereof, in regard to the banknotes and/or coins, respectively subjected to the supplement process in the money handling machine 10.

As used herein, the “checking data” means the information on the quantity or the like of money for each denomination thereof, in regard to the banknotes returned to the banknote reject slot 22 and/or banknote return slot 23 from each recycling banknote storage unit 27, and/or coins returned to the coin return slot 32 from each recycling coin storage unit 34. Further, the “exchange from large denomination to small denomination data” as used herein refers to the data or information on the quantity or the like of money for each denomination thereof, in regard to the banknotes and/or coins, respectively subjected to the exchange from large denomination to small denomination process in the money handling machine 10, and the “exchange from small denomination to large denomination data” as used herein refers to the data or information on the quantity or the like of money for each denomination thereof, in regard to the banknotes and/or coins, respectively subjected to the exchange from small denomination to large denomination process in the money handling machine 10. In addition, the “counting data” means herein the information on the quantity or the like of money for each denomination thereof, in regard to the banknotes and/or coins, respectively subjected to the counting process in the money handling machine 10.

Further, as used herein, the “amount of money data” refers to the information on the quantity or the like of money for each denomination thereof, in regard to the banknotes and/or coins, respectively stored in the banknote storage cassette 41 and/or coin storage cassette 42 of the money storage unit 40. The “system data” means herein the data or information on the specification or the like of each component of the banknote handling machine 20, coin handling machine 30 and money storage unit 40, respectively provided to the money handling machine 10. The “failure data” refers to the information on a point, kind or the like of each failure or damage generated in the money handling machine 10, and the “program data” refers to the information on each program provided to the control unit 15.

In this way, each of the above data or information on the money handling machine 10 can be obtained, as needed, from the cash center 13 or data center 14. Therefore, the money deposit/dispense system can be optionally operated, without the need for any authorized operator being always present in the store. Further, the above data may include the date and time on which the information is obtained, recognition information on the store and/or recognition information on the money handling machine. Thus, the information on the time that the data was obtained, information on the money handling machine from which the data was sent, and any other like information can be defined. Additionally, with respect to the closing data, delivery data, collection by staff data, depositing data, dispensing data, supplement data, checking data, exchange from large denomination to small denomination data, exchange from small denomination to large denomination data, counting data and failure data, such data may include the information on the operator, such as the ID information or the like thereof, and/or information on the date and time on which each operation was performed. Thus, the information on the date, time and manner that the money was handled in the money handling machine 10, the information on the person who handled the money, as well as the information on the money handling machine 10 that handled the money, can be managed.

As described above, according to the money deposit/dispense system of this embodiment, the banknote handling machine 20 and/or coin handling machine 30 is arranged to be controlled under the first control authority, while the coin storage unit 40 is arranged to be controlled under the second control authority. In addition, when receiving the delivery command, the control unit 15 performs the delivery process for feeding the banknotes and/or coins, respectively stored in each recycling banknote storage unit 27 of the banknote handling machine 20 and/or each recycling coin storage unit 34 of the coin storage unit 30, to the money storage unit 40 (during this operation, the control authority, under which the banknotes and/or coins respectively subjected to the delivery process are controlled, will be changed from the first control authority to the second control authority). Meanwhile, when receiving the closing command, the control unit 15 performs the closing process for calculating the amount of money regarding the closing process, which is the amount of money or quantity of money for each denomination thereof, in regard to the banknotes and/or coins respectively subjected to the delivery process in the predetermined period of time. Further, when receiving the delivery-with-closing command, the control unit 15 performs the delivery-with-closing process, such that the delivery process is first performed, and then the closing process is automatically performed, in succession, after the delivery process is ended. As such, if the closing process is required to be performed in succession to the end of the delivery process, both the delivery process and closing process following this delivery process can be performed, in one operation, by only inputting the delivery-with-closing command to the control unit 15. Accordingly, this operation can eliminate the need for providing the waiting time after the operator performs the delivery process. Therefore, the working efficiency of the operator can be significantly enhanced.

1. A money handling machine for handling money, comprising:
a casing;
a money recycling mechanism provided in the casing and configured to be controlled under a first control authority; and
a money storage unit provided in the casing and configured to be controlled under a second control authority; wherein
the money storage unit is configured to store therein the money,
the money recycling mechanism is configured to temporarily store the money taken from the exterior to the interior of the casing, in a recycling money storage unit thereof, and is adapted to feed the money stored in the recycling money storage unit or money taken from the exterior to the interior of the casing, to the money storage unit, or return such money to the exterior of the casing, and
there is further provided a control unit, the control unit performing a delivery-with-closing process, when receiving a delivery-with-closing command, so as to first perform a delivery process for feeding the money stored in the recycling money storage unit of the money recycling mechanism to the money storage unit, and then perform, in succession to the end of the delivery process, a closing process for calculating the amount of money regarding the closing process, which is the amount of money or quantity of money for each denomination thereof, in regard to the money having been subjected to the delivery process in a predetermined period of time.

2. The money handling machine according to claim 1, wherein, when the control unit receives information on the amount of money regarding the closing process, together with the delivery-with-closing command, the control unit first performs the delivery process, for the money corresponding to the amount of money obtained by subtracting the amount of money having been subjected to this delivery process during the predetermined period of time before the delivery-with-closing process, from the amount of money regarding the closing process in the received information, and then performs the closing process.

3. The money handling machine according to claim 1, wherein, when the control unit receives information on the amount of money to be delivered, together with the delivery-with-closing command, the control unit first performs the delivery process for the money corresponding to the amount of money to be delivered in the received information, and then performs the closing process.

4. The money handling machine according to claim 1, wherein, when the control unit receives information on the amount of money to be left or information on the number of money to be left for each denomination thereof, together with the delivery-with-closing command, the control unit allows the money to be left in the recycling money storage unit, corresponding to the amount of money to be left or corresponding to the number of money to be left for each denomination thereof in the received information, while performing the delivery process for the surplus money, and then performs the closing process.

5. The money handling machine according to claim 1, wherein when the control unit receives only the delivery-with-closing command, the control unit allows the money to be left in the recycling money storage unit, corresponding to a preset amount of money or preset number of money for each denomination thereof, while performing the delivery process for the surplus money, and then performs the closing process.

6. The money handing machine according to claim 1, wherein when the amount of money stored in the recycling money storage unit reaches a predetermined amount, the control unit first performs the delivery process until the amount of money stored in the recycling money storage unit is reduced to a storage amount set in advance, which is less than the predetermined amount, and then automatically performs the closing process, in succession to the end of the delivery process.

7. A money deposit/dispense system, comprising:
the money handling machine according to claim 1; and
a central control unit provided to be isolated from the money handling machine, and connected, for communication, with the money handling machine,
wherein, after the control unit performs the closing process, the control unit transmits information on the amount of money regarding the closing process to the central control unit.
